(19) United States
(12) Patent Application Publication
(10) Pub. No.: US 2002/0018267 A1
(43) Pub. Date: Feb. 14, 2002

(54) Methods and apparatus for adaptive optical distortion compensation using magneto-optic device

(75) Inventors: Fengqing Sun, Boca Raton, FL (US); Jun Tao, Columbia, MD (US)

Correspondence Address: YAFO NETWORKS, INC., 1340 F CHARWOOD RD., HANOVER, MD, 21076, US

(73) Assignee: Yafo Networks, Inc., Hanover, MD

(21) Appl. No.: 09/898,394

(22) Filed: Jul. 3, 2001

Related U.S. Application Data
(60) Provisional application No. 60/224,033, filed on Aug. 9, 2000.

(51) Int. Cl. H04J 14/02; H04B 10/00

(52) U.S. Cl. 359/161; 359/124

(57) ABSTRACT

Methods and apparatus for adaptively compensating optical signal distortion, including polarization mode dispersion, chromatic dispersion, and the like, using magneto-optic devices are provided. One optical distortion compensator according to this invention includes at least one polarization transformer that includes a magneto-optic rotator in combination with a variable delay device. The magneto-optic rotator, after transforming the state of polarization of an incident optical signal, delivers the transformed signal to the variable delay device.

### CROSS-REFERENCE TO RELATED APPLICATIONS

This claims priority under 35 U.S.C. 119(e)(1) to U.S. Provisional Patent Application No. 60/224,033, filed Aug. 9, 2000, which is hereby incorporated by reference in its entirety.

### FIELD OF THE INVENTION

The present invention relates to apparatus and methods of adaptively compensating optical distortion in optical signals, and particularly to compensating polarization mode dispersion, chromatic dispersion, and the like using a polarization controller having at least one magneto-optic device.

### BACKGROUND OF THE INVENTION

Polarization mode dispersion (hereinafter, “PMD”) is a signal distortion effect that can limit optical fiber transmission distances at high bit rates, such as 10 Gbits/sec and above. PMD is caused by variations in birefringence along the optical path that causes the orthogonal optical signal polarization modes to propagate at different velocities. The primary cause of PMD is the asymmetry of the fiber-optic strand. Fiber asymmetry may be inherent in the fiber from the manufacturing process, or it may be a result of mechanical stress on the deployed fiber. The inherent asymmetries of the fiber are fairly constant over time. In other cases the statistical nature of PMD results in unexplained PMD changes that can last for much longer periods of time, with the potential for prolonged degradation of data transmission.

Components used to split, combine, multiplex, demultiplex, amplify, reroute, or otherwise modify optical signals can also contribute to PMD.

Unlike chromatic dispersion, which remains nearly static, PMD is dynamic and statistical in nature, making it a particularly difficult problem to correct. The statistical nature of PMD is such that it changes over time and varies with wavelength. Thermal and mechanical effects, such as diurnal heating and cooling, vibration from passing vehicles, fiber movement in aerial spans, and cabling disturbances by craftspersons (e.g., during patch panel rerouting) have all been shown to cause PMD. These events can momentarily increase the PMD in a fiber span and briefly affect the transmission quality of an optical signal. Because these effects are sometimes momentary, they are hard to isolate and diagnose. In fact, these types of problems are sometimes known as “ghosts” because they occur briefly and mysteriously, and cannot be replicated during a system maintenance window.

In long fiber spans, enough PMD can accumulate such that bits arriving at the receiver begin to interfere with one another, degrading transmission quality. This effect becomes more pronounced as transmission rates get higher (and bit periods get shorter). Generally, PMD exceeding ten percent of the bit period is considered detrimental. At 10 Gbits/sec, the bit period is 100 psecs, which implies that any span that exhibits PMD greater than 10 psecs may be “PMD-limited.” This generally only occurs in extraordinarily long spans, and those incorporating older fiber.

To date, spans deploying 10 Gbits/sec rates have been specially-selected or “link-engineered” to low PMD fibers. As the 10 Gbits/sec data transmission rate standard becomes more prevalent, however, PMD challenged fibers must be deployed, or lit, and specialized engineering resources may become an alternative, though cost prohibitive. PMD is expected to be a significant and growing concern in systems transmitting information at 40 Gbits/sec and higher. For example, at 40 Gbits/sec, the PMD tolerance is only 2.5 psecs. At this transmission rate, every span is potentially PMD-limited.

Regeneration, inverse multiplexing, and PMD compensation are three ways of reducing the effects of PMD.

Regeneration involves, at each termination point of a span, converting the light into an electrical signal and then reconverting the electrical signal back into an optical signal for transmission along the next span. Regeneration of an optical signal is performed on each wavelength independently; meaning that each of the signals carried by a single fiber must demultiplexed, converted and reconverted, and then remultiplexed with the other wavelengths. Regeneration of optical signals was a widely used approach on all optical-transmission systems until the advent of optically amplified dense wavelength division multiplexed (“DWDM”) systems in the mid 1990's. Before that time, regenerators limited PMD and boosted the power level of the optical signal.

Once multiple wavelengths appeared on long-haul fibers, however, optical amplifiers replaced the use of regenerators for boosting signal power across multiple wavelengths. Although optical amplifiers are economical, they do not reduce PMD and may actually increase it. Therefore, optical amplification alone may not be an option on fiber spans with high PMD.

Inverse multiplexing is a second approach and is a generic term for the transport of a signal from a subscriber across multiple paths in the network at a lower bandwidth rate than it was received from the subscriber. A common example of inverse multiplexing is an application that has been around for many years in the access network: the transport of 10 Mbits/sec Ethernet links across multiple DS-1 transmission paths. Inverse multiplexing for support of 10 Gbits/sec services operates by disassembling a subscriber's service (e.g., an OC-192c transmission from a core router) for transport across the network by an inverse-multiplexing device. The service could be disassembled into 2.5 Gbits/sec “chunks” for transport, then reassembled at the destination point and handed off to the destination core router. Because PMD is less of an issue at 2.5 Gbits/sec, inverse multiplexing provides a “workaround” solution for moving 10 Gbits/sec across a fiber network with PMD issues.

In the third approach, compensation for PMD fixes the optical signal before it is read and interpreted by the receiver at the end of the fiber path. PMD compensation methods have been explored since the potential bandwidth limitation of PMD was first recognized in the mid-1990's. Early generations of PMD compensators, however, were limited in performance, addressing only a small range of PMD.

A somewhat related type of optical distortion is chromatic dispersion (hereinafter, “CD”). CD causes optical pulses launched along the transmission medium to propagate at different velocities for different wavelengths of light. For example, some frequency components of a launched optical pulse will propagate slower than other frequency components, thus spreading out the pulse. Some of the methods used to compensate for CD in optical fibers are described by Ip U.S. Pat. No. 5,557,468, Ishikawa et al. U.S. Pat. No. 5,602,666, and Shigematsu et al. U.S. Pat. No. 5,701,188, all of which are hereby incorporated by reference in their entireties. Moreover, products are commercially available for providing broadband variable chromatic dispersion compensation (see, e.g., the dispersion compensator sold under the trademark POWERSHAPER™, by Avanex Corp. of Freemont, Calif.).

With respect to both PMD and CD, optical pulses are assumed to be bandwidth limited, and that the corresponding compensation corrects for differential delay.

Ozeki et al. describe a system that compensates delay caused by PMD in “A Polarization-Mode-Dispersion Equalization Experiment Using A Variable Equalizing Optical Circuit Controlled By A Pulse-Waveform-Comparison Algorithm,” OFC'94 Technical Digest, at 62-64 (1994), which is hereby incorporated by reference in its entirety. According to Ozeki et al., the system compensates for differential group delay (hereinafter, “DGD”) by subjecting a distorted optical signal to a polarization transformation, transmitting the transformed signal through a birefringent fiber, subjecting the transmitted signal to one or two additional polarization transformations, and transmitting the transformed signal through another birefringent fiber. Patscher et al. describes another compensation scheme similar to Ozeki et al. in “A Component For Second-Order Compensation Of Polarisation-Mode Dispersion” in Electronics Letters, Vol. 33, No. 13., at 1157-1159 (Jun. 19, 1997). Neither publication, however, describes how the polarization state of an optical signal is transformed.

Fishman et al. U.S. Pat. No. 5,930,414, which is hereby incorporated by reference in its entirety, describes a system for compensating first-order polarization mode dispersion. Because PMD is dynamic, the system shown by Fishman et al. adaptively compensates for DGD by varying the orientation of a birefringence element.

The apparatus shown by Fishman et al. includes a polarization transformer coupled in series with a birefringence element. The distorted optical signal is input to the polarization transformer. The birefringence element provides a compensated optical signal, which is optically tapped and converted by a photodetector into an electrical signal. The electrical signal is then amplified and the distortion in the amplified photocurrent is measured by a distortion analyzer that generates a control voltage in accordance with the measured distortion. The distortion analyzer outputs a control voltage that approaches a maximum value when distortion in the optical signal due to first order PMD approaches a minimum. The control voltage is provided as feedback to the polarization transformer and the birefringence element in a feedback loop. The polarization transformer and the birefringence element are thus continually varied via feedback control to compensate for optical distortion resulting from PMD.

The polarization transformer used by Fishman et al. includes a lithium niobate (i.e., LiNbO₃) transducer, such as the one disclosed in Heisman U.S. Pat. No. 5,212,743. The transducer includes a lithium niobate substrate, operates with a titanium-diffused, single-mode waveguide, and employs three cascaded electrode sections corresponding to three rotatable fractional wave plates. The lithium niobate transducer is relatively bulky and incompatible for use with many current integrated circuits. Also, the electrode sections require relatively high drive control voltages. For these reasons, conventional PMD compensation systems are not readily compatible for use with conventional integrated circuitry.

LCDs have been used to control polarization, particularly in display devices. Use of LCDs in optical communications is also known, but is limited. For example, Rumbaugh et al. U.S. Pat. No. 4,979,235 (hereinafter, “Rumbaugh”) employs LCDs as polarization transformers in a state-of-polarization matching scheme to minimize the difference between the polarization state of an input signal and a local signal. Also, Clark et al. U.S. Pat. No. 5,005,952 (hereinafter, “Clark”) shows an LCD being used as a polarization transformer for coherent detection. In this case, the LCD is used to match the state of polarization at the output of a transmission fiber to that of a local oscillator beam. Rumbaugh and Clark do not, however, use an LCD to compensate PMD or any other type of optical distortion.

Another type of liquid crystal polarization control device is known, but it is relatively slow because it uses nematic liquid crystal material in a conventional way (Asham et al., “A practical liquid crystal polarization controller,” in Proc. ECOC '90, Amsterdam, Vol. 1, at 393-396 (1990)). Moreover, the device was not used to compensate polarization mode dispersion.

In an effort to provide an alternative to relatively high-cost lithium niobate devices, and relatively slow nematic liquid crystal devices, a deformed-helical ferroelectric liquid crystal device was introduced that compensates for PMD (See Sandel et al., “10-Gb/s PMD Compensation Using Deformed-Helical Ferroelectric Liquid Crystals,” ECOC '98, Madrid, Spain (September, 1998), at 555). This alternative, however, uses a highly esoteric liquid crystal material that is difficult to manufacture and manipulate, and has many intrinsic defects.

It is known that magneto-optic devices can be used as optical isolators. An optical isolator is a device that transmits light in only one direction. For example, Brandle, Jr. et al. U.S. Pat. No. 4,981,341 describes an apparatus that includes a magneto-optic isolator that uses a garnet layer and which utilizes a novel temperature compensation scheme. Also, Ohta et al. U.S. Pat. No. 5,151,955 describes an optical isolator that includes three or four birefringent crystals and two magneto-optic elements between two light waveguides.

It is further known that magneto-optic devices can be used as optical attenuators and modulators. An optical attenuator is a device designed to decrease the flux density of a light beam, generally through absorption and scattering of the beam. An optical modulator is a device that transmits light in response to a modulated control signal. For example, Fukushima U.S. Pat. Nos. 5,889,609 and 6,018,412 describe a magneto-optic crystal-based optical attenuator that provides light through a polarizer. The intensity of a light beam output depends on the strengths and directions of two magnetic fields applied to the magneto-optic crystal. Iwatsuka et al. also describes an optical attenuator and an optical modulator that uses a magneto-optic element in combination with diffraction phenomena.

Magneto-optic elements have also been used as polarization rotators. A polarization rotator is a device that rotates the plane of polarization of linearly polarized light by a predetermined angle, maintaining its linearly polarized nature. For example, Lefevre et al. U.S. Pat. Nos. 4,615,582 and 4,733,938 (hereinafter, “Lefevre et al”) describe a magneto-optic rotator for providing additive faraday rotations in a loop of optical fiber. In particular, a single, continuous strand of fiber optic material is wrapped about a mandrel to form oval-shaped loops having parallel sides and curved ends. Lefevre et al. state that their magneto-optic rotator can be used in an optical isolator, a modulator, and a magnetometer.

The magneto-optic elements shown and described in the above-identified references do not, however, show or suggest using them in the context of an adaptive feedback loop, and particularly in the field of adaptive optical distortion compensation.

Therefore, it would be desirable to provide a compact, integratable, and low-cost optical distortion compensator.

It would also be desirable to provide apparatus and methods for adaptively compensating optical distortion, particularly PMD and CD, thereby enabling high-speed optical data transfer with minimal data transmission errors.

### SUMMARY OF THE INVENTION

It is therefore an object of the present invention to provide a compact, integratable, and low-cost optical distortion compensator.

It is another object of the present invention to provide apparatus and methods for adaptively compensating accumulated optical distortion, especially using magneto-optic elements.

It is also an object of the present invention to provide apparatus and methods for adaptively compensating optical distortion, particularly PMD and CD, thereby enabling high-speed optical data transfer with minimal data transmission errors.

In accordance with this invention, an optical distortion compensator system is provided. The system includes at least a first polarization transformer, a variable delay device, a photodetector, and a feedback controller. The polarization transformer can include at least one magneto-optic device (hereinafter, “MOD”) having a common optical path that passes through the MOD. The transformer has an input region that provides a distorted optical signal having a first polarization state along the optical path and an output region for receiving the optical signal after evolving through the MOD. The distorted optical signal is transformed to have a second polarization state by evolving through the MOD.

The variable delay device is in optical series with the first polarization transformer and includes a first birefringent element, a second birefringent element, and a variable retarder positioned between the first and second birefringent elements. The variable retarder can also include one or more MODs. The photodetector converts at least a portion of the transformed optical signal into an electrical signal. The feedback controller is electrically coupled to the photodetector and the transformer. The feedback controller generates at least one control signal in response to receiving the electrical signal and provides the control signal to each of the MODs for compensating the optical distortion.

According to another aspect of this invention, an optical distortion compensator system that adaptively compensates for distortion in an optical signal is provided. The compensator system includes a PMD compensator and a CD compensator in series with the PMD compensator, and a distortion analyzer positioned downstream from the CD and PMD compensators. The PMD compensator and the CD compensator can be optically coupled in free space or any type of optical guide, such as an optical fiber. The analyzer converts at least a portion of the optical signal into an electrical signal that contains information regarding the distortion level of the optical signal, generates at least one control signal in response to the electrical signal, and adaptively controls the CD compensator and the PMD compensator with the at least one control signal.

According to yet another aspect of this invention, an optical signal distortion compensator for processing wavelength-multiplexed signals is provided. The compensator can include a wavelength demultiplexer, a plurality of polarization transformers, a plurality of photodetectors, and a plurality of feedback controllers. The wavelength demultiplexer can receive an optical wavelength-multiplexed signal and demultiplex the multiplexed signal into a plurality of optical wavelength demultiplexed signals. Each of the plurality of polarization transformers is coupled to each of the demultiplexed signals. A transformer can include at least one MOD that changes a state of polarization of the respectively coupled demultiplexed signals based on a respective control signal to compensate for any optical distortion in the demultiplexed signal. In this way, a corresponding compensated optical signal is provided. The plurality of photodetectors converts portions of the compensated optical signals into electrical signals. The plurality of feedback controllers is coupled to the plurality of photodetectors and generates the control signals based on the electrical signals.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an optical signal distortion compensator according to this invention;

FIG. 2 shows a schematic representation of a stack of MODs that can be used in the polarization transformers of FIG. 1 according to this invention;

FIG. 3 shows another optical signal distortion compensator according to this invention for use with a single channel optical signal;

FIG. 3A shows yet another optical signal distortion compensator according to this invention in which a polarization mode dispersion compensator and a chromatic dispersion compensator are separated;

FIG. 3B shows still another optical signal distortion compensator according to this invention in which a polarization mode dispersion compensator and a chromatic dispersion compensator are separated.

FIG. 4 shows still another optical signal distortion compensator according to this invention for use with a wavelength multiplexed optical signal;

FIG. 5 shows an illustrative optical signal distortion compensator system according to the present invention, including a plurality of optical distortion compensators, each of which compensate respective wavelength channels of a wavelength multiplexed optical signal; and

FIG. 6 shows yet another optical signal distortion compensator according to this invention.

### DETAILED DESCRIPTION OF THE INVENTION

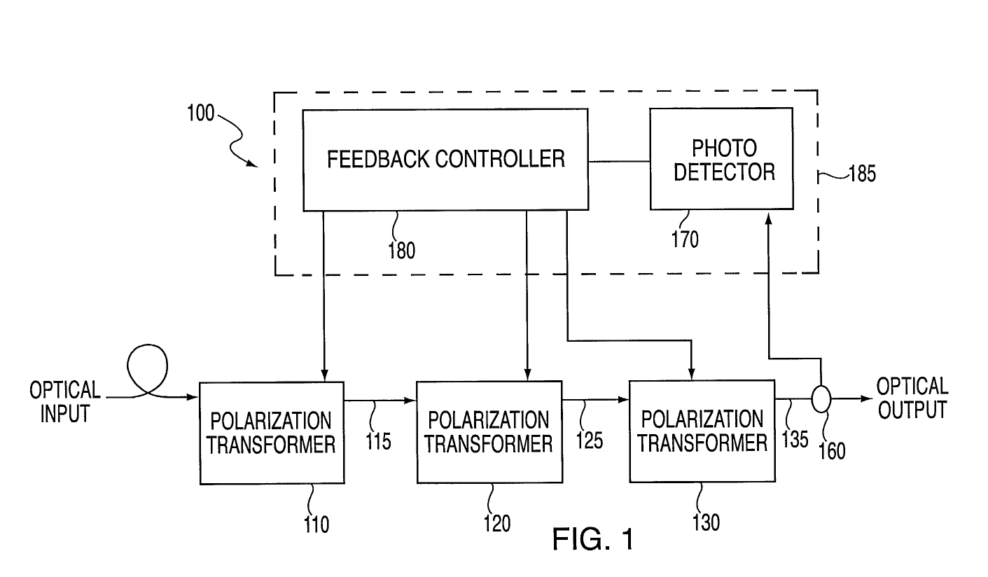

FIG. 1 shows an illustrative optical signal distortion compensator constructed in accordance with this invention. In compensator 100, a distorted optical signal is provided to first polarization transformer 110. The optical distortion may result from polarization mode dispersion and/or chromatic dispersion, but can also result from other effects.

As described more fully below, polarization transformers 110, 120, and 130 change the states of polarization of an optical signal to compensate for the distortion in response to a control signal provided by feedback controller 180. Feedback controller 180 acts essentially as a kind of distortion analyzer (e.g., analyzer 185) that generates a control signal based on the level of distortion reflected in the electrical signal provided by photodetector 170. Polarization transformer 110, for example, includes at least one MOD. In operation, the MOD rotates the polarization state of an optical signal based on an applied magnetic field.

The PMD compensated optical signal is output from polarization transformer 110 along fiber 115 to a subsequent stage of optical distortion compensator 100. Thus, the first stage of compensator 100 can be considered to include polarization transformer 110 and fiber 115. Fiber 115 provides compensated optical signal to second polarization transformer 120 for additional polarization transformation. The optical signal compensated by polarization transformer 120 is provided to birefringent fiber 125. Thus, the second stage of compensator 100 can be considered to include polarization transformer 120 and fiber 125. Fiber 125 provides twice compensated optical signal to third polarization transformer 130 for even more polarization transformation. Polarization transformers 120 and 130 can each include one or more MODs and can be configured in substantially same way as polarization transformer 110, using a control signal provided by feedback controller 180. It will be appreciated that additional stages can be added as desired.

Optical tap 160 is disposed along fiber 135 and provides a tapped at least partially compensated optical signal as an output of the optical distortion compensator.

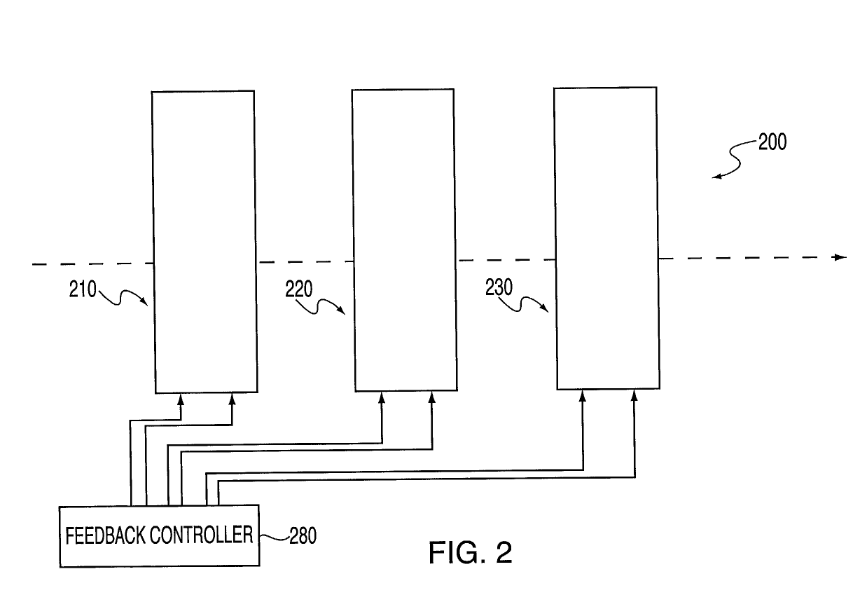

Polarization transformers 110, 120, and 130 can each include one or more MODs, and preferably provide endless rotation. Other materials that can be used to construct the polarization transformers include, for example, lithium niobate and PLZT. If multiple MODs are used in a particular transformer, they can be stacked, as schematically shown in FIG. 2.

MOD 210 includes at least one magneto-optic element according to this invention. Materials that can be used to construct a magneto-optic element for use in an adaptive optical distortion compensator include, for example, yttrium-iron-garnet (hereinafter, “Y₃Fe₅O₁₂” or “YIG”), bismuth-substituted gadolinium-iron-garnet (hereinafter, “Gd₃₋ₓBiₓFe₅O₁₂” or “GdBiG”), bismuth-substituted terbium-iron-garnet (hereinafter, “Tb₃₋ₓBiₓFe₅O₁₂” or “TbBiIG”).

Moreover, nanophotonic devices based on the Faraday-Stark effect can be used as magneto-optic (i.e., magneto-optoelectronic) elements in accordance with this invention. In particular, quantum well and nanostructured semiconductors, such as CdMnTe quantum well structures and GaAs:Mn materials, which can be controlled with an electric field, are described in Lee et al. U.S. Pat. No. 5,640,021.

In one embodiment, feedback controller 280 can include a current source for driving an electromagnet within MOD 210. Alternatively, feedback controller 280 can include a voltage source for applying an electric field to a magneto-optoelectronic material, via electrodes (not shown), within MOD 210. MODs 220 and 230 can be similar in construction to MOD 210.

It will be appreciated that the MOD stack shown in FIG. 2 is illustrative only and should not be considered limiting. For example, the MOD stack can have two or more stacked MODs and should not be limited to the three shown in FIG. 2. Also, MODs 210, 220, and 230 can be stacked in any convenient orientation with respect to one another and can be to be controlled by the same or different control signals. The MOD stack enables endless polarization transformation, thereby expanding the range of polarization control. It will be appreciated that the individual MODs that comprise the MOD stack can be rigidly affixed to each other directly with adhesive or indirectly through a stacking structure. In any case, it is preferable that the spacers that normally exist between individual MODS are not in the active optical path through the MOD to prevent optical loss, dispersion, and other types of optical degradation. Suh U.S. patent application Ser. No. 09/724,982, titled “SEAL PATTERN FOR LIQUID CRYSTAL DEVICES,” filed Nov. 28, 2000), which is hereby incorporated by reference in its entirety, shows how a “spacerless” LCD can be constructed. Moreover, any spacers placed between two adjacent MODs preferably are not placed in the optical path of the optical signal. The intra-stacking methods shown in Suh can be adapted for inter-stacking as well.

Returning to FIG. 1, polarization transformer 130 provides at least a partially compensated optical signal to birefringent element 135, which supplies the signal to photodetector 170, which is preferably of the high-speed variety. Photodetector 170 converts the received optical signal into an electrical signal, which is supplied to feedback controller 180. This can be performed in a fashion similar to the one shown by Fishman. Photodetector 170 can include an amplifier for amplifying the electrical signal prior to output to feedback controller 180.

Feedback controller 180 measures the distortion in the electrical signal output from photodetector 170 and generates a voltage that is proportional to the distortion in the compensated optical signal output from polarization transformer 130. Feedback controller 180 subsequently generates control signals for polarization transformers 110, 120, and 130 based on the generated voltage. The MODs of polarization transformers 110, 120, and 130 change the polarization state of the optical signal based on the control signal(s) in order to minimize the optical distortion that may occur due to PMD, CD, or the like and optimize the detected signal quality. The feedback loop is preferably continuous.

Optical signal distortion compensators according to this invention can include any number of polarization transformers, depending on the optical link (e.g., span). For example, an optical distortion compensator need not be limited to three polarization transformers 110, 120, and 130, as shown in FIG. 1. Generally, an optical link can include any number n of optical fiber segments. Each segment can have a different effective eccentricity and length. Moreover, each segment can be positioned at different rotational positions about its optical axis and can be subject to dynamic stresses. Therefore, each segment can have a different principal state of polarization.

An optical signal distortion compensator according to this invention that includes n polarization transformers enables optimum compensation of optical distortion created by n segments of optical fiber. Although n polarization transformers can reproduce exactly an optical link having n segments, the construction of a compensator with a large number of segments can be impractical because n control signals can be required. Accordingly, a compensator according to the present invention can include m polarization transformers, where m is less than n and greater or equal to 1 (i.e., 1≦m<n).

Each of birefringent elements 115, 125, and 135 preferably impart a maximum delay τ to the compensated optical signal output from the corresponding polarization transformer, although it will be appreciated that τ can be different for each transformer. Therefore, each of polarization transformers 110, 120, and 130 can provide a tunable compensation between 0 and τ seconds because each transformer rotates the polarization state of the optical signal with respect to the principal states of polarization of the birefringent elements. For example, if birefringent elements 115, 125, and 135 can impart delays of τ₁, τ₂, and τ₃ seconds, respectively, then an optical distortion compensator having three birefringent elements can generally provide a tunable compensation of between 0 and (τ₁+τ₂+τ₃) seconds. Similarly, if an optical distortion compensator includes two polarization transformers, each of which is appropriately coupled to a birefringent fiber having a fixed delay τ, a maximum compensation of approximately 2τ seconds can be achieved.

As explained above, any type of magneto-optic material can be used to construct MODs in the polarization transformers according to this invention.

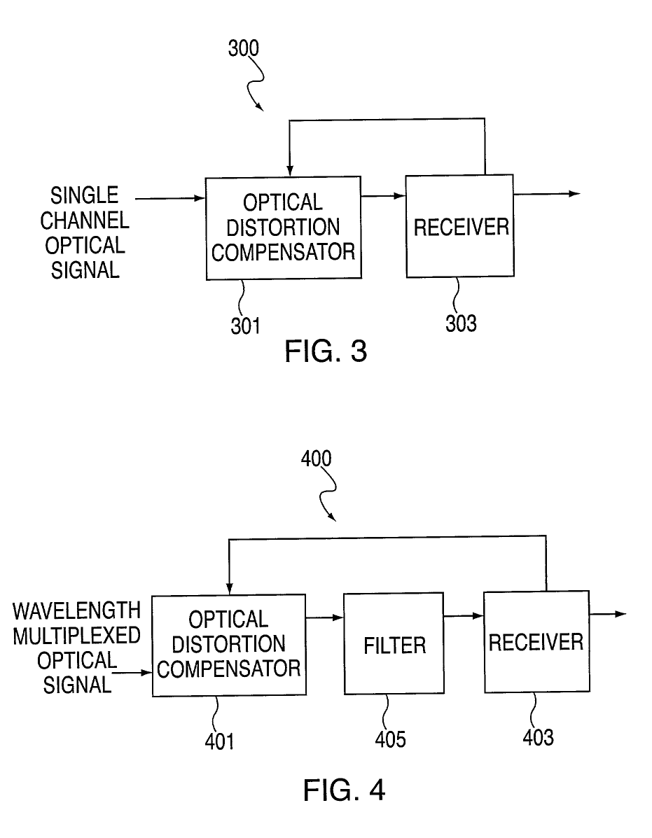

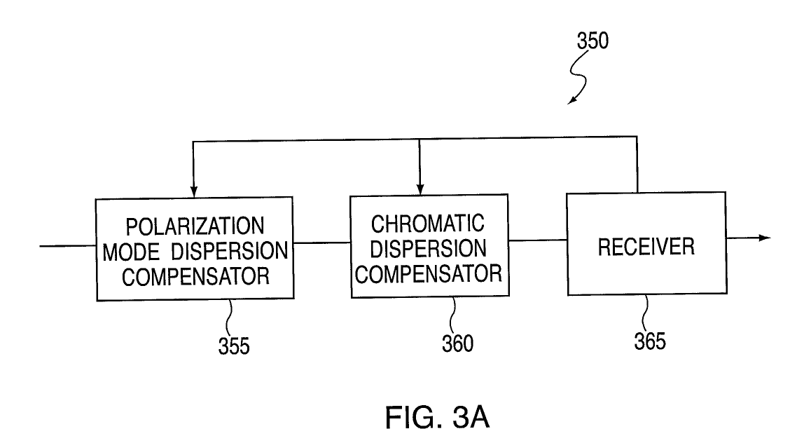

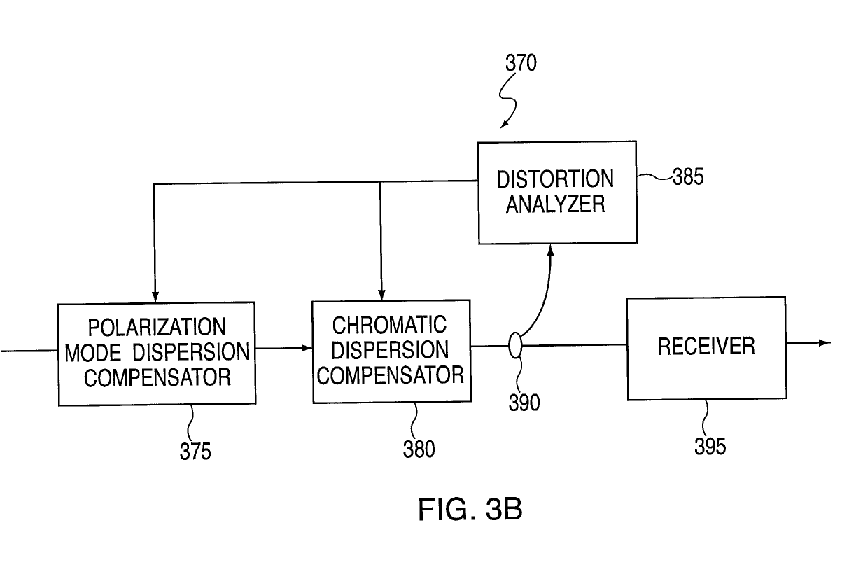

FIG. 3 shows illustrative unit 300, which includes optical distortion compensator 301 for a single channel optical signal according to this invention. Compensator 301 includes a plurality of polarization transformers, such as transformers 110, 120 and 130, which are linked together by birefringent fibers and a feedback controller, such as feedback controller 180. As shown in FIG. 3, receiver 303 can provide an electrical signal for controlling compensator 301. Alternatively, an optical tap can be used to direct a portion of the optical output from compensator 301 to a photodetector, which provides the electrical signal for the feedback controller. It will be appreciated that other feedback configurations are also possible.

Each polarization transformer includes at least one LCD that alters the state of polarization of the optical signal in accordance with its respective control signal. Receiver 303 includes a photodetector, such as photodetector 170, which taps the compensated optical signal output from compensator 301 and converts the tapped signal to an electrical signal. As mentioned above, the optical tap can alternatively be placed before receiver 403. A feedback controller within optical distortion compensator 301 generates control signals, which are based on the electrical signal, and provides them to the individual polarization transformers within compensator 301. Receiver 303 can also provide either a compensated optical signal or a converted electrical signal as an output thereof. The polarization transformers within optical distortion compensator 301 compensate the optical distortion (e.g., PMD alone, CD alone, PMD+CD, etc.) in the optical signal.

FIG. 3A shows yet another optical signal distortion compensator according to this invention in which a polarization mode dispersion compensator and a chromatic dispersion compensator are separated. Unit 350 includes polarization mode dispersion compensator 355, chromatic dispersion compensator 360, and receiver 365. Receiver 365 can provide an electrical signal for controlling compensators 355 and 360. Alternatively, an optical tap can be used to direct a portion of the optical output from compensator 360 to a photodetector, which provides the electrical signal for the feedback controller. The compensators can have separate active feedback controllers, a shared controller, or a combination of both. It will be appreciated that each controller will actively (e.g., continuously or periodically) adjust the degree of compensation so that the optical signal received by the receiver has a minimum amount of distortion. It will further be appreciated that compensators 355 and 360 can be in any serial order.

FIG. 3B shows another optical signal distortion compensator according to this invention in which a polarization mode dispersion compensator and a chromatic dispersion compensator are separated. Unit 370 includes polarization mode dispersion compensator 375, chromatic dispersion compensator 380, and distortion analyzer 385. In this case, receiver 365 is not part of the feedback loop. Rather, distortion analyzer 385 is responsible for receiving a portion of at least a partially compensated optical signal output from compensators 375 and 380. The portion of the output is provided to distortion analyzer 385 via optical tap 390. Distortion analyzer 385 includes at least a photodetector for converting the optical signal portion into an electrical signal, and may further contain a processor for generating one or more compensator control signals. Alternatively, distortion analyzer 385 can send a raw or semi-processed electrical signal to compensators 375 and 380, which can include their own processors for generating control signals. It will further be appreciated that compensators 375 and 380 can be in any serial order.

The compensators can have separate active feedback controllers, a shared controller, or both. It will be appreciated that the each of the controllers will actively (continuously or periodically) adjust the degree of compensation so that the optical signal received by the receiver has a minimum amount of distortion. Also, the PMD and CD compensators can be controlled in an alternating or substantially simultaneous fashion.

Adding a filter that selects a particular wavelength can modify any of units 300, 350, and 370. For example, FIG. 4 shows unit 400, which is similar to unit 300, except that it includes filter 401 between optical distortion compensator 401 and receiver 403. Filter 405 passes only a selected wavelength of the compensated optical signal output from optical distortion compensator 401. Receiver 403 taps the optical signal passed by filter 405 and converts it to an electrical signal. The feedback controller in optical distortion compensator 401 generates various signals for controlling the polarization transformers within optical distortion compensator 401 based on the electrical signal. These control signals compensate the wavelength multiplexed optical signal only at the selected wavelength passed by filter 405. Receiver 403 can also provide as an output the compensated optical signal or the converted electrical signal. The polarization transformers within optical distortion compensator 401 compensate for optical distortion in the channel selected by filter 405.

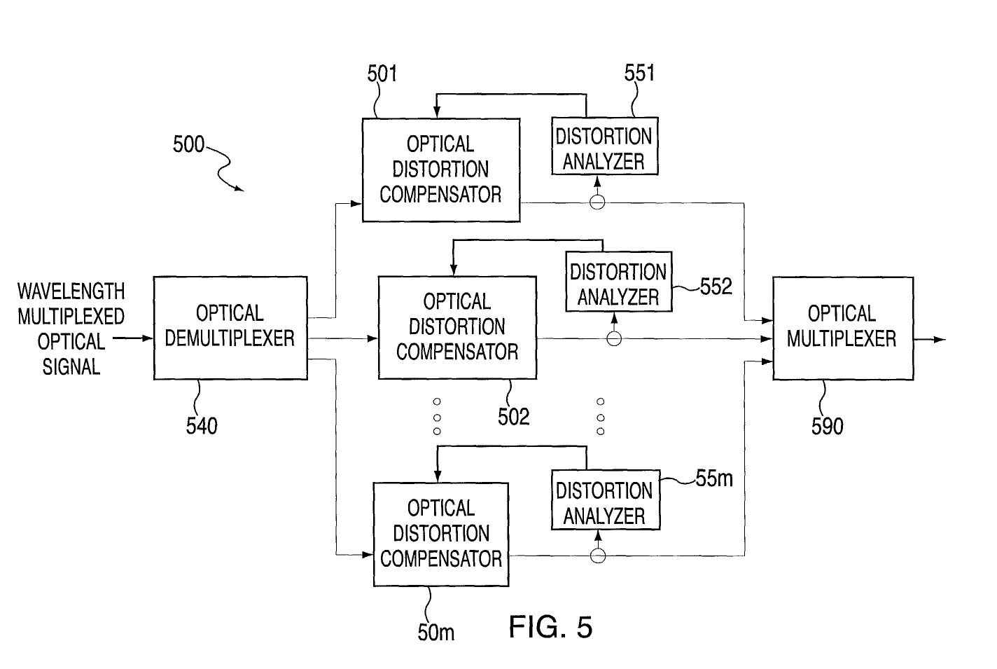

FIG. 5 shows an illustrative system that demultiplexes a wavelength multiplexed optical signal before separately, and preferably simultaneously, compensating the individual demultiplexed optical channels. As shown in FIG. 5, system 500 includes optical demultiplexer 540, a plurality of optical distortion compensators 501, 502, . . . , 50 m, a plurality of optical distortion analyzers 551, 552, . . . , 55 m, and optical multiplexer 590. In this case, each of analyzers 551, 552, . . . , 55 m, can either be full distortion analyzers capable of receiving an optical signal and generating a control signal, or simply photodetectors capable of providing an electrical signal that can be subsequently processed by each of the optical distortion compensators. Each of compensators 501, 502, . . . , 50 m can be any type of optical distortion compensator, such as a PMD compensator, a CD compensator, or a combination thereof.

During operation, a wavelength multiplexed optical signal is provided to the input of optical demultiplexer 540. Demultiplexer 540 provides single optical channels to each of optical distortion compensators 501, 502, . . . , 50 m and analyzers 551, 552, 55 m, which can be configured to operate in substantially the same way as described with respect to FIG. 3. Polarization transformers within optical distortion compensators 501, 502, . . . , 50 m change the polarization state of the corresponding wavelength channel optical signals based on control signals generated by the feedback controllers (which can be in compensators 501, 502, . . . , 50 m or analyzers 551, 552, . . . , 55 m) based on electrical feedback signals provided by analyzers 551, 552, . . . , 55 m.

Analyzers 551, 552, . . . , 55 m can tap their respective compensated single channel optical signals from the optical distortion compensators 501, 502, . . . , 50 m and convert them into electrical signals. The compensated signals are also provided as outputs of analyzers 551, 552, . . . , 55 m to optical multiplexer 590. Multiplexer 590 multiplexes the compensated optical signals and generates a compensated wavelength multiplexed optical signal. As described above, the polarization transformers within compensators 501, 502, . . . , 50 m compensate for optical distortion in each of the single channel optical signals. This system can provide midspan or midlink distortion compensation.

The system shown in FIG. 5 can be modified for use in terminal equipment by omitting multiplexer 590 (not shown). In this terminal embodiment, each demultiplexed compensated optical signal is provided for subsequent electrical or optical processing by a receiver. Alternatively, the tapped compensated optical signals, which can be converted into electrical signals, can also be provided as the corresponding outputs of the receivers.

Another end-terminal system architecture is also possible. In this architecture, the optical distortion compensator can, for example, be constructed in a similar fashion as the one shown in FIG. 1. As already described above, the compensator can include a plurality of polarization transformers linked together by birefringent elements, a photodetector, and a feedback controller. Each of the polarization transformers in the optical distortion compensator change the state of polarization of the multiplexed optical signal in accordance with control signals generated by the feedback controller. The photodetector in the compensator receives a tapped at least partially compensated wavelength multiplexed optical signal and converts that signal into an electrical feedback signal that is output to a feedback controller. As discussed above, optical feedback schemes are also possible.

The compensated wavelength multiplexed optical signal is provided by the compensator to a demultiplexer, which demultiplexes the compensated wavelength multiplexed optical signal into separate wavelength channel optical signals. These signals are then output to respective receivers for use at end terminals. Alternatively, the receivers can convert the single channel optical signals to electrical signals. In this embodiment, the entire bandwidth of the wavelength multiplexed optical signal is first compensated for optical distortion and is then demultiplexed and separately provided for subsequent decoding and processing.

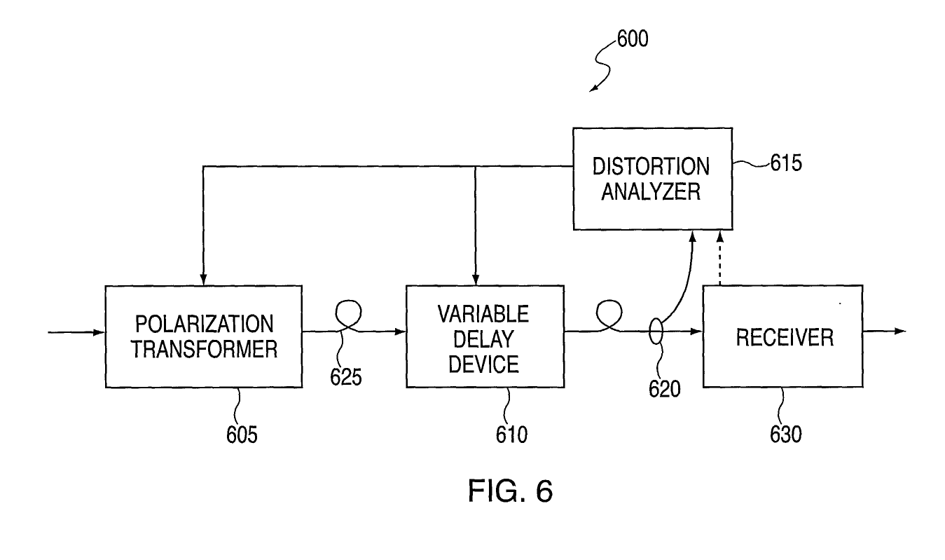

FIG. 6 shows another optical signal distortion compensator according to this invention in which at least one polarization transformer and at least one variable delay device are placed in optical series. Unit 600 at least includes polarization transformer 605, variable delay device 610, and distortion analyzer 615. As shown in FIG. 6, receiver 630 is not part of the feedback loop, but could be as described above. Distortion analyzer 615 is responsible for receiving a portion of at least a partially compensated optical signal output from transformer 605 and variable delay device 610.

The order of transformer 605 and variable delay device 610 is not important. Also, the portion of the output provided to distortion analyzer 615 is provided via optical tap 620. In this case, distortion analyzer 615 can include at least a photodetector for converting the optical signal portion into an electrical signal, and may further contain a processor for generating one or more compensator control signals. Alternatively, distortion analyzer 615 can send a raw or semi-processed electrical signal to transformer 605 and variable delay device 610, which can include their own processors for generating control signals. Transformer 605 and variable delay device 610 are preferably optically coupled with a birefringent element, such as a polarization maintaining fiber 625.

Variable delay device 610 can be constructed from a first birefringent element, a second birefringent element, and a variable retarder positioned between the first and second birefringent elements. One or both of the birefringent elements can include a polarization maintaining fiber. There are various other ways that are well known in the art to construct variable delay devices that primarily vary delay, although such devices can also change polarization and introduce some second order effects. These could also be used as a variable delay device according to this invention.

An aspect of the present invention is that the variable retarder of variable delay device 610 need not be a full polarization transformer. Rather, the retarder can be two, or even one MOD. Although the variable retarder can also include more MODs (or other types of rotators), one or two MODs is sufficient for providing the variable delay required from device 610 and minimizes the amount of higher order distortion introduced into the system.

Transformer 605 and device 610 can have separate or shared feedback controlling circuitry (or processors), or both. It will be appreciated that each of the controllers actively (continuously or periodically) adjusts the degree of compensation so that the optical signal received by the receiver has a minimum amount of distortion.

It will be appreciated that the above description is given by way of illustration only and thus should not be considered as limiting. For example, although three wavelength channels are demultiplexed in FIG. 5, it will be appreciated that the wavelength multiplexed optical signal can be demultiplexed into any number of wavelength channel optical signals as desired. Also, any type of selectable wavelength filter can be used in FIG. 4. Moreover, a plurality of filters can be used to provide a plurality of wavelength dependent inputs for each distortion analyzer. Also, the number of polarization transformers within each optical distortion compensator and the number of stacked LCDs in the polarization transformers should not be limited to the number shown in the FIGS.

According to one aspect of the invention, the optical signal distortion compensator can include at least one polarization transformer that has at least one MOD for changing the state of polarization of an incident optical signal. The optical distortion compensator compensates for at least first-order optical distortion. Since the polarization transformers of this invention can use MODs, relatively low control voltages can be used compared with the voltages used to control other electro-optic devices, such as lithium niobate and lanthanum modified lead zirconate titanate (“PLZT”).

Also, the polarization transformers can be made more compact than conventional polarization controllers that include lithium niobate transformers. For example, as many as twelve or more MOD stages can be stacked and integrated into a corresponding space of a conventional lithium niobate polarization transformer that only includes three stages. Also, a stack of MODs provides more degrees of freedom than a single MOD, as well as endless polarization control.

Thus, one skilled in the art will appreciate that the present invention can be practiced by other than the described embodiments, which are presented for purposes of illustration and not of limitation, and the present invention is limited only by the claims which follow.

What is claimed is:

1. An optical distortion compensator system comprising:
at least a first polarization transformer comprising a plurality of magneto-optic rotators having a common optical path that passes through said plurality of rotators, wherein said transformer has an input region for providing a distorted optical signal along said optical path, said signal having a first polarization state, and an output region for receiving said optical signal after evolving through said plurality of rotators, wherein said distorted optical signal is transformed to have a second polarization state by evolving through said devices;
a variable delay device in optical series with said first polarization transformer;
a photodetector that converts at least a portion of the transformed optical signal into an electrical signal; and
a feedback controller electrically coupled to said photodetector and said transformer, wherein said feedback controller generates at least one control signal in response to receiving said electrical signal and provides said at least one control signal to each of said rotators for compensating said optical distortion.

2. The system of claim 1 wherein said variable delay device comprises a first birefringent element, a second birefringent element, and a variable retarder positioned between said first and second birefringent elements.

3. The system of claim 2 wherein said variable retarder comprises a magneto-optic rotator.

4. The system of claim 2 wherein said variable retarder is a magneto-optic rotator that controls the effective orientation of said first and second birefringent elements.

5. The system of claim 4 wherein said variable retarder is a single magneto-optic rotator.

6. The system of claim 2 wherein at least one of said birefringent elements is a polarization maintaining fiber.

7. The system of claim 6 further comprising a second polarization transformer comprising a plurality of magneto-optic rotators sharing said common optical path, wherein said second polarization transformer is also controlled by said feedback controller.

8. A method of dynamically compensating distortion in an optical signal using a distortion compensator system comprising: (1) a polarization mode dispersion (“PMD”) compensator containing a magneto-optic element-based polarization transformer, (2) a chromatic dispersion (“CD”) compensator in optical series with said PMD compensator, and (3) a distortion analyzer in optical series with and downstream from said CD and PMD compensators, wherein said PMD compensator and said CD compensator are optically connected by a birefringent connecting element, said method comprising:
converting at least a portion of said optical signal into at least one electrical signal, said electrical signal containing information regarding the level of distortion of said optical signal;
generating at least one control signal based on said electrical signal; and
controlling said CD compensator and said PMD compensator with said at least one control signal.

9. The method of claim 8 wherein said controlling comprises:
controlling said CD compensator with a first of said at least one control signal; and
controlling said PMD compensator with a second of said at least one control signal.

10. The method of claim 9 wherein said generating comprises generating at least one control signal that, when received by at least one of said compensators, reduces the level of distortion at an optical receiver downstream from said system.

11. The method of claim 10 wherein said polarization transformer comprises a plurality of magneto-optic rotators.

12. The method of claim 11 wherein said PMD compensator further comprises a variable delay device that includes: (1) a first variable retarder in optical series with and downstream from said birefringent connecting element, and (2) a second birefringent element in optical series with and downstream from said first variable retarder, and wherein said controlling said PMD compensator comprises adjusting said first variable retarder with said at least one control signal.

13. An optical signal distortion compensator system comprising:
a polarization transformer coupled to an optical signal, said polarization transformer including at least one magneto-optic rotator that changes a polarization state of the optical signal based on a control signal for compensating optical distortion and providing a compensated optical signal, wherein said polarization transformer comprises a plurality of stacked spacerless magneto-optic rotators;
a photodetector that converts the compensated optical signal into an electrical signal; and
a feedback controller coupled to said photodetector, wherein said feedback controller generates the control signal based on the electrical signal.

14. The system of claim 13 further comprising at least one additional polarization transformer coupled in series with said polarization transformer, wherein each of said transformers include at least one liquid crystal device, said polarization transformer and said at least one polarization transformer sequentially compensating optical distortion of the optical signal.

15. The system of claim 13 wherein said polarization transformers each includes at least one polarization maintaining fiber that provides an optical signal output therefrom.

16. The system of claim 15 wherein said at least one additional polarization transformer includes a first polarization transformer, and wherein said polarization maintaining fibers of said polarization transformer and said first polarization transformer respectively impart delays of τ₁ and τ₂ seconds and provide a tunable compensation between 0 to (τ₁+τ₂) seconds.

17. The system of claim 15 wherein said at least one additional polarization transformer includes first and second polarization transformers, and wherein said polarization maintaining fiber of said polarization transformer, said first polarization transformer, and said second polarization transformer respectively impart delays of τ₁, Tτ2, and τ₃ seconds and provide a tunable compensation between 0 to (τ₁+τ₂+τ₃) seconds.

18. The system of claim 13 wherein said at least one magneto-optic rotator comprises a magneto optoelectronic rotator.

19. The system of claim 13 wherein the optical distortion is selected from a group consisting of polarization mode dispersion, chromatic dispersion, and a combination thereof.

20. The system of claim 13 further comprising an optical tap between said polarization transformer and said photodetector, said optical tap providing the compensated optical signal as an output of the optical receiver.

21. The system of claim 13 wherein the received optical signal is an optical wavelength multiplexed signal, the optical receiver further comprising:
a wavelength selection filter coupled to said polarization transformer, wherein said filter passes only a selected wavelength of the compensated optical signal to said photodetector, and wherein said photodetector provides the electrical signal based on the compensated optical signal passed by said filter and said polarization transformer compensates the optical wavelength multiplexed signal at the selected wavelength based on the electrical signal.

22. The system of claim 13 wherein said polarization transformer comprises a polarization maintaining fiber coupled to an output of said at least one magneto-optic rotator, and wherein said polarization maintaining fiber provides the compensated optical signal.

23. An optical signal distortion compensator comprising:
a wavelength demultiplexer for receiving an optical wavelength-multiplexed signal, wherein said demultiplexer is for demultiplexing the multiplexed signal into a plurality of optical wavelength demultiplexed signals;
a plurality of polarization transformers respectively coupled to each of the plurality of demultiplexed signals, each of said plurality of transformers including at least one magneto-optic rotator that changes a state of polarization of the respectively coupled demultiplexed signal based on a respective control signal to compensate for any optical distortion in said demultiplexed signal, thereby providing a corresponding compensated optical signal;
a plurality of photodetectors that respectively convert a portion of said compensated optical signals into electrical signals; and
a plurality of feedback controllers respectively coupled to said plurality of photodetectors, said plurality of feedback controllers generating the control signals based on the electrical signals.

24. The compensator of claim 23 further comprising a plurality of optical taps coupled respectively between said plurality of polarization transformers and said plurality of photodetectors, said plurality of optical taps providing a portion of said compensated optical signals as outputs.

25. The compensator of claim 24 further comprising a wavelength multiplexer coupled in series to and downstream from said plurality of optical taps, wherein said wavelength multiplexer multiplexes the compensated outputs to provide an optical wavelength multiplexed output signal.

26. A method of dynamically compensating for polarization mode dispersion and chromatic dispersion in an optical signal using active feedback, said method comprising:
compensating for polarization mode dispersion by transforming a state of polarization of the optical signal based on a control signal using a polarization transformer, wherein said polarization transformer comprises at least one magneto-optic rotator to compensate for optical distortion and provide a polarization mode dispersion compensated optical signal;
compensating for chromatic dispersion using a chromatic dispersion compensator based on said control signal, thereby providing a chromatic dispersion compensated optical signal;
receiving at least part of said compensated optical signal;
converting said part of said compensated optical signal into an electrical signal; and
generating the control signal based on the electrical signal.

27. The method of claim 26 wherein said compensating PMD and said compensating CD are controlled in an alternating fashion.

28. The method of claim 26 wherein said compensating PMD and said compensating CD are controlled in a substantially simultaneous fashion.
